(19) United States
(12) Patent Application Publication
(10) Pub. No.: US 2025/0369376 A1
(43) Pub. Date: Dec. 4, 2025

(54) HONEYCOMB FILTER

(71) Applicant: NGK INSULATORS, LTD., Nagoya-Shi (JP)

(72) Inventors: Hirotaka YAMAMOTO, Nagoya-Shi (JP); Yuki TAKAMURO, Nagoya-Shi (JP); Shiori SHIRAKI, Nagoya-Shi (JP); So SUGIURA, Nagoya-Shi (JP); Shota HAGIWARA, Nagoya-Shi (JP)

(73) Assignee: NGK INSULATORS, LTD., Nagoya-Shi (JP)

(21) Appl. No.: 18/983,669

(22) Filed: Dec. 17, 2024

(30) Foreign Application Priority Data
Jun. 4, 2024 (JP) 2024-090548
Oct. 4, 2024 (JP) 2024-174920

(51) Int. Cl. F01N 3/022; B01D 39/20

(52) U.S. Cl. CPC F01N 3/0222; B01D 39/2068; B01D 2201/62; B01D 2275/30; F01N 2340/00; F01N 2370/22

(57) ABSTRACT

A honeycomb filter includes a pillar-shaped honeycomb structure having a porous partition wall disposed to surround a plurality of cells and
a plugging portion, wherein
a thickness of the partition wall is 152 to 305 μm,
a porosity of the partition wall is 35% to 70%,
an average pore diameter of the partition wall is 7 μm to 24 μm,
a porous body constituting the partition wall has a communication pore which opens to the surface of the partition wall and communicates with a pore inside the partition wall, and the communication pore has a narrow part where the diameter is partially narrowed, and
in a virtual single pore obtained by virtually dividing the communication pore at the narrow part, an average of a ratio (X/Y) of a minimum width X (μm) to a maximum width Y (μm) passing through the center of gravity of the virtual single pore is 0.51 to 1.00.

This application is based upon and claims the benefit of priority from the prior Japanese Patent Applications Nos. 2024-090548, filed on Jun. 4, 2024, and 2024-174920, filed on Oct. 4, 2024, the entire contents of which are incorporated herein by reference.

### TECHNICAL FIELD

The present invention relates to a honeycomb filter. More particularly, the present invention relates to a honeycomb filter capable of suppressing performance variations in pressure loss and filtration efficiency.

### DESCRIPTION OF RELATED ART

As a means for reducing the emission of particulate matter contained in exhaust gas emitted from the internal combustion engine, there is known a method of providing a particulate filter designed to trap particulate matter by depositing it in the exhaust gas passage of the internal combustion engine (for example, Patent Document 1). Hereinafter, the particulate matter contained in exhaust gas may be referred to as “PM”. The “PM” is an abbreviation for “particulate matter.”

As a particulate filter for purifying exhaust gas, for example, a honeycomb filter using a honeycomb structure is known. The honeycomb structure includes a partition wall made of porous ceramics such as cordierite and a plurality of cells defined by the partition wall. In the honeycomb filter, plugging portions are provided in the honeycomb structure described above so as to plug open ends at the inflow end face side and open ends at the outflow end face side of the plurality of cells alternately.

### [Patent Document 1] JP-A-2002-219319

By installing a honeycomb filter as a particulate filter on exhaust system of a vehicle, PM contained in exhaust gas emitted from the engine can be trapped by the honeycomb filter, and PM emission can be reduced. However, when the honeycomb filter is installed in the exhaust system, pressure loss in exhaust system pipe increases, which leads to deterioration in fuel efficiency of the vehicles. Therefore, there is a demand for developing a honeycomb filter capable of suppressing an increase in pressure loss while maintaining the trapping performance. In particular, such a demand is stronger in honeycomb filters represented by gasoline particulate filters (GPF) and diesel particulate filters (DPF).

Here, the trapping performance and the pressure loss performance of the gasoline particulate filter (GPF) or the diesel particulate filter (DPF) may be greatly influenced by pore condition of the porous body constituting the partition wall of the honeycomb filter. Conventionally, the pore condition of the porous body has been evaluated by properties such as porosity and average pore diameter, but when the shape of the pore of the porous body is non-uniform, the pore condition may not be sufficiently grasped by the conventional evaluation as described above. Therefore, for example, even in the case of a honeycomb filter that is judged to be equivalent by the evaluation in the measurement under the same condition, there is a possibility that variations are easily generated in the trapping performance and the pressure loss performance described above and stable performance cannot be obtained.

### SUMMARY OF THE INVENTION

The present invention has been made in view of the problems with the prior arts described above. According to the present invention, a honeycomb filter capable of suppressing performance variations in pressure loss and filtration efficiency is provided.

According to the present invention, a honeycomb filter described below is provided.
[1] A honeycomb filter including: a pillar-shaped honeycomb structure having a porous partition wall disposed so as to surround a plurality of cells which serve as fluid through channels extending from an inflow end face to an outflow end face; and
   a plugging portion provided at either an end on the inflow end face side or an end on the outflow end face side of the cell; wherein
   a thickness of the partition wall is 152 to 305 μm,
   a porosity of the partition wall is 35% or more and 70% or less,
   an average pore diameter of the partition wall is 7 μm or more and 24 μm or less,
   a porous body constituting the partition wall has a communication pore which opens to the surface of the partition wall and communicates with a pore inside the partition wall, and the communication pore has a narrow part in which a diameter of the communication pore is partially narrowed in the partition wall, and
   in a virtual single pore obtained by virtually dividing the communication pore at the narrow part, when a minimum width passing through the center of gravity of each of the virtual single pore is defined as X (μm) and a maximum width passing through the center of gravity of each of the virtual single pore is defined as Y (μm), an average value of a ratio (X/Y) of the minimum width X to the maximum width Y of the virtual single pore is 0.51 or more and 1.00 or less.
[2] The honeycomb filter according to [1], wherein a standard deviation of the ratio (X/Y) of the minimum width X to the maximum width Y of the virtual single pore is 0.2 or less.
[3] The honeycomb filter according to [1] or [2], wherein an average value of an equal area circle equivalent diameter of virtual pore dividing surfaces that virtually divide the communication pore into the virtual single pores at the narrow part is 8.8 to 30 μm.
[4] The honeycomb filter according to [1] or [2], wherein a porosity of the partition wall is 45% or more, and the partition wall is made of a porous body containing cordierite as a main component.
[5] The honeycomb filter according to [4], wherein an average value of the ratio (X/Y) of the minimum width X to the maximum width Y of the virtual single pore is 0.80 or more and 1.00 or less.
[6] The honeycomb filter according to [4], wherein an average pore diameter of the partition wall is 10 μm or less.
[7] The honeycomb filter according to [1] or [2], wherein the partition wall is made of a porous body containing silicon carbide as a main component.
[8] The honeycomb filter according to [7], wherein an average value of the ratio (X/Y) of the minimum width X to the maximum width Y of the virtual single pore is 0.58 or more and 1.00 or less.
[9] The honeycomb filter according to [7], wherein an average value of the equal area circle equivalent diameter of the virtual pore dividing surfaces that virtually divide the communication pore into the virtual single pores at the narrow part is 9 to 30 μm.

The honeycomb filter of the present invention can suppress performance variations in pressure loss and filtration efficiency. Therefore, particularly in a gasoline particulate filter (GPF) or a diesel particulate filter (DPF), performance variations in pressure loss and filtration efficiency can be suppressed, and stable performance can be satisfactorily secured.

### BRIEF DESCRIPTION OF DRAWINGS

FIG. 1 is a perspective view schematically showing one embodiment of the honeycomb filter of the present invention.

FIG. 2 is a plan view showing an inflow end face side of the honeycomb filter shown in FIG. 1.

FIG. 3 is a sectional view schematically showing a section A-A′ of FIG. 2.

FIG. 4 is a conceptual diagram of voxel data used in determining a minimum width X (μm) and a maximum width Y (μm) of a virtual single pore.

FIG. 5 is a conceptual diagram schematically showing a communication pore of a porous body.

FIG. 6 is a conceptual diagram for explaining the minimum width X and the maximum width Y of the virtual single pore in the communication pore shown in FIG. 5.

### DETAILED DESCRIPTION

The following will describe embodiments of the present invention; however, the present invention is not limited to the following embodiments. Therefore, it should be understood that those created by adding changes, improvements or the like to the following embodiments, as appropriate, on the basis of the common knowledge of one skilled in the art without departing from the spirit of the present invention are also covered by the scope of the present invention.

### (1) Honeycomb Filter

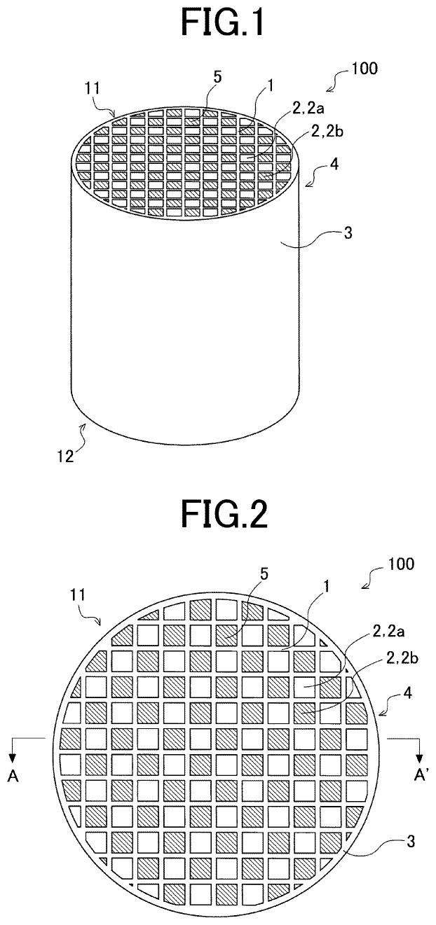

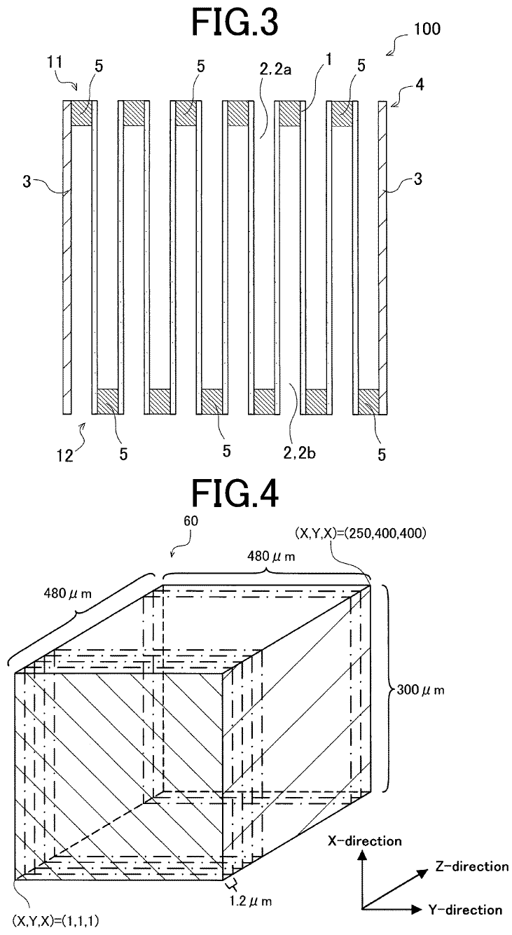

One embodiment of the honeycomb filter of the present invention is a honeycomb filter 100 as shown in FIGS. 1 to 3. Here, FIG. 1 is a perspective view schematically showing one embodiment of a honeycomb filter of the present invention. FIG. 2 is a plan view showing an inflow end face side of the honeycomb filter shown in FIG. 1. FIG. 3 is a sectional view schematically showing a section A-A′ of FIG. 2.

As shown in FIGS. 1 to 3, the honeycomb filter 100 includes a honeycomb structure 4 and a plugging portion 5. The honeycomb structure 4 is of pillar-shaped having a porous partition wall 1 disposed to surround a plurality of cells 2 which serve as fluid through channels extending from an inflow end face 11 to an outflow end face 12. In the honeycomb filter 100, the honeycomb structure 4 has a pillar shape, and further includes a circumferential wall 3 at the outer peripheral side surface. In other words, the circumferential wall 3 is provided so as to encompass the partition wall 1 provided in a grid pattern.

The plugging portions 5 are disposed at open ends on the inflow end face 11 side or the outflow end face 12 side of each of the cells 2. In the honeycomb filter 100 shown in FIGS. 1 to 3, the plugging portions 5 are disposed at open end at the end on the inflow end face 11 side of the predetermined cell 2 and open end at the end on the outflow end face 12 side of the remaining cell 2, respectively. The cell 2 in which the plugging portion 5 is disposed at the open end on the outflow end face 12 side and the inflow end face 11 side is opened is defined as an inflow cell 2a. Further, the cell 2 in which the plugging portion 5 is disposed at the open end on the inflow end face 11 side and the outflow end face side is opened is defined as an outflow cell 2b. The inflow cell 2a and the outflow cell 2b are preferably disposed alternately with the partition wall 1 therebetween. In addition, it is preferable that a checkerboard pattern is thereby formed by the plugging portions 5 and “the open ends of the cells 2” on both end faces of the honeycomb filter 100.

In the honeycomb filter 100, the material of the partition wall 1 of the honeycomb structure 4 is not particularly limited, and examples thereof include cordierite, silicon carbide, and silicon-silicon carbide-based composite material. For example, the partition wall 1 of the honeycomb structure 4 may be made of a porous body containing cordierite as a main component, or may be made of a porous body containing silicon carbide or silicon-silicon carbide-based composite material as a main component. Although not particularly limited, it is preferable that the partition wall 1 of the honeycomb structure 4 of the honeycomb filter 100 is made of a porous body containing cordierite as a main component or a porous body containing silicon carbide as a main component. It is more preferable that the partition wall 1 is made of cordierite or silicon carbide except for components inevitably contained therein.

The honeycomb filter 100 has a thickness of the partition wall 1 of 152 to 305 μm. By setting the thickness of the partition wall 1 to the above numerical value, it is possible to effectively suppress the increase in pressure loss while ensuring sufficient filtration efficiency as an exhaust gas purification filter. Further, by setting the thickness of the partition wall 1 to the above numerical value, the structural strength of the honeycomb filter 100 can also be ensured. For example, when the thickness of the partition wall 1 is less than 152 μm, it is not preferable in terms of lowering the filtration efficiency and lowering the mechanical strength. When the thickness of the partition wall 1 exceeds 305 μm, pressure loss increases greatly, which is not preferable. Although not particularly limited, the thickness of the partition wall 1 is preferably 165 to 305 μm, and more preferably 208 to 305 μm. The thickness of the partition wall 1 can be measured with a scanning electron microscope or a microscope, for example.

The honeycomb filter 100 has a porosity of the partition wall 1 of 35% or more and 70% or less. The porosity of the partition wall 1 is measured by the mercury press-in method, and can be measured using, for example, Autopore 9500 (trade name) manufactured by Micromeritics. To measure the porosity, a part of the partition wall 1 is cut out from the honeycomb filter 100 to obtain a test piece, and the test piece thus obtained can be used for the measurement. The porosity of the partition wall 1 is not particularly limited as long as it is 35% or more and 70% or less, but is preferably 35% or more and 67% or less, and more preferably 35% or more and 65% or less. If the porosity of the partition wall 1 is less than 35%, it is not preferable in that pressure loss is increased. On the other hand, when the porosity of the partition wall 1 exceeds 70%, it is not preferable in that the structural strength of the honeycomb filter 100 decreases. When the partition wall 1 of the honeycomb structure 4 is made of a porous body containing cordierite as a main component, it is preferable that the porosity of the partition wall 1 is 45% or more and 70% or less.

The honeycomb filter 100 has an average pore diameter of the partition wall 1 of 7 μm or more and 24 μm or less. The average pore diameter of the partition wall 1 is measured by the mercury press-in method, and can be measured using, for example, Autopore 9500 (trade name) manufactured by Micromeritics. To measure the average pore diameter, a part of the partition wall 1 is cut out from the honeycomb filter 100 to obtain a test piece, and the test piece thus obtained can be used for the measurement. When the average pore diameter of the partition wall 1 is less than 7 μm, it is not preferable in terms of increasing pressure loss. On the other hand, when the average pore diameter of the partition wall 1 exceeds 24 μm, the filtration efficiency deteriorates, which is not preferable. Here, when the partition wall 1 of the honeycomb structure 4 is made of a porous body containing cordierite as a main component, it is preferable that the average pore diameter of the partition wall is 10 μm or less.

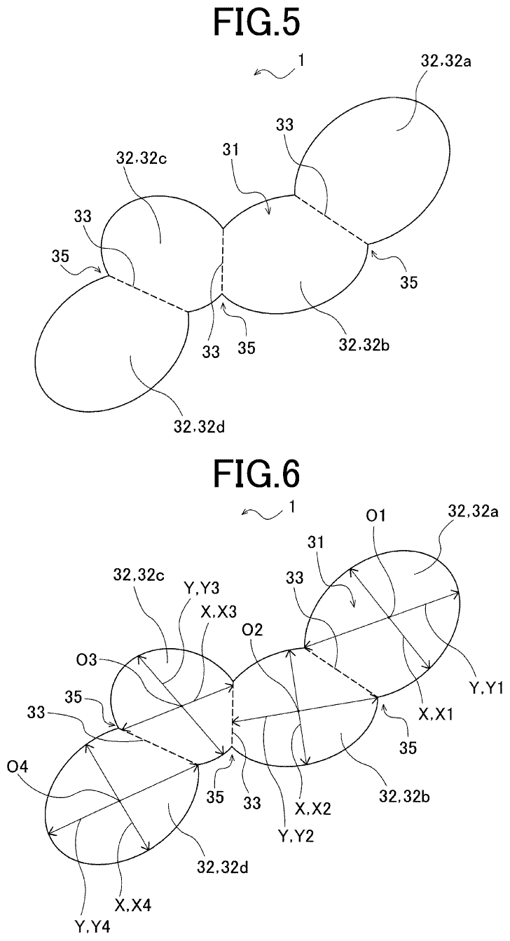

The porous body constituting the partition wall 1 has a communication pore that opens to the surface of the partition wall 1 and communicates with pore inside the partition wall 1. For example, as shown in FIGS. 5 and 6, the porous body constituting the partition wall 1 has a communication pore 31 in which a number of pores formed inside the partition wall 1 are connected. The communication pore 31 serves as a fine flow path for the passage of fluid through the partition wall 1. In the partition wall 1 partitioning an inflow cell 2a and an outflow cell 2b as shown in FIG. 3, the communication pore 31 is preferably formed such that one surface of the side partitioning the inflow cell 2a and the other surface of the side partitioning the outflow cell 2b are communicated with each other. In FIGS. 5 and 6, the communication pore 31 is drawn as if it is closed on the left and right sides of the paper surface, but the communication pore 31 is formed so as to be three-dimensionally continuous within the partition wall 1.

As shown in FIGS. 5 and 6, the communication pore 31 has a narrow part 35 in which a diameter of the communication pore 31 is partially narrowed in the partition wall 1. Here, each individual part obtained by virtually dividing the communication pore 31 at the narrow part 35 is defined as a virtual single pore 32 (32a, 32b, 32c, 32d). Here, a minimum width passing through the center of gravity O of each virtual single pore 32 (32a, 32b, 32c, 32d) is defined as X (μm), and a maximum width passing through the center of gravity O of each virtual single pore 32 (32a, 32b, 32c, 32d) is defined as Y (μm). Hereinafter, the above-described minimum width may be referred to as “minimum width X (μm)”, and the above-described maximum width may be referred to as “maximum width Y (μm)”. In the honeycomb filter 100 of the present embodiment (see FIG. 1, the same applies hereinafter), the average value of the ratio (X/Y) of the minimum width X (μm) to the maximum width Y (μm) of the virtual single pore 32 is 0.51 or more and 1.00 or less. In FIGS. 5 and 6, a state in which the communication pore 31 is virtually divided into a virtual single pore 32 at the narrow part 35 is two-dimensionally illustrated, but as will be described later, the virtual division of the communication pore 31 is three-dimensionally performed using a three-dimensional model.

The above-described average value of X/Y is an index of sphericity of the virtual single pore 32, and the closer the average value of X/Y is to 1.00, the closer pore shape of the virtual single pore 32 is to a true sphere. Here, the communication pore 31 is formed by connecting a plurality of pores in the porous body, and when the plurality of pores are connected to each other to form the communication pore 31, the connected part corresponds to the narrow part 35 described above. Therefore, the pore shape of the porous body constituting the partition wall 1 can be made as close to a true sphere as possible by setting the average value of X/Y to the above numerical value. Then, by bringing the individual pore shapes closer to a true sphere, the width of the narrow part 35 (hereinafter, sometimes referred to as the “neck diameter” of the communication pore 31) becomes more uniform in width regardless of how the pores are connected to each other, and a part where the diameter of the communication pore 31 becomes extremely narrow is reduced. Therefore, it is possible to appropriately secure the fine flow path in the partition wall 1, and it is possible to appropriately maintain the trapping performance as a filter while effectively suppressing the increase in pressure loss. On the other hand, when the above-described average value of X/Y is less than 0.51, the pore shape of the virtual single pore 32 becomes closer to an ellipsoid than a true sphere, and when the plurality of pores are connected to each other to form the communication pore 31, there is a high possibility that the neck diameter of the communication pore 31 becomes extremely narrow or wider. In particular, when the neck diameter of the communication pore 31 becomes extremely narrow, the fine flow path in the partition wall 1 is likely to be blocked, which tends to lead to an increase in pressure loss. On the contrary, when the neck diameter of the communication pore 31 becomes extremely wide, the filtration efficiency may be deteriorated. Therefore, by setting the average value of X/Y to 0.51 or more and 1.00 or less, the individual pore shapes forming the communication pore 31 can be brought close to a true sphere, so that performance variations in pressure loss and filtration efficiency can be extremely effectively suppressed.

The minimum width X (μm) and the maximum width Y (μm) of the virtual single pore 32 obtained by virtually dividing the communication pore 31 at the narrow part 35 can be determined by the following method. The minimum width X (μm) and the maximum width Y (μm) of the virtual single pore 32 obtained by virtually dividing the communication pore 31 at the narrow part 35 are calculated using three-dimensional voxel data 60 (see FIG. 4) obtained by performing CT scanning on the partition wall 1. FIG. 4 is a conceptual diagram of voxel data used in determining the minimum width X (μm) and the maximum width Y (μm) of a virtual single pore. First, a thickness direction of the partition wall 1 (for example, refer to FIG. 3) is taken as the X direction, an axial direction of the cell 2 (for example, a vertical direction in FIG. 3) is taken as the Y direction, and the XY plane is taken as an imaging cross section. Next, a plurality of image data are acquired by performing CT scanning of the partition wall 1 so as to capture a plurality of images by shifting the imaging cross section in the Z direction perpendicular to the XY direction, and the voxel data 60 as shown in FIG. 4 is obtained based on the image data. The resolution in each of the X, Y, and Z directions is set to 1.2 μm, and the resulting cube having one side of 1.2 μm is the minimum unit of the three-dimensional voxel data 60, that is, the voxel. The image data of the imaging cross section obtained by CT scanning is a plane data having no thickness in the Z direction, but each imaging cross section is treated as having a thickness corresponding to the distance (1.2 μm) in the Z direction of the imaging cross section. That is, each two-dimensional pixel of the image data is treated as a cube (voxel) having one side of 1.2 μm. As shown in FIG. 4, the size of the voxel data 60 is a rectangular parallelepiped having 300 μm in the X direction (=1.2 μm×250 voxels), 480 μm in the Y direction (=1.2 μm×400 voxels), and 480 μm in the Z direction (=1.2 μm×400 voxels). The position of each voxel is represented by X, Y, and Z coordinates (the coordinate value 1 corresponds to 1.2 μm, which is the length of one side of the voxel), and it is distinguished whether the voxel is a spatial voxel representing a space (pore) or an object voxel representing an object. The distinction between the spatial voxel and the object voxel is made by binarization processing using the mode method as follows. The plurality of image data actually obtained by CT scanning are luminance data for each X, Y, and Z coordinate. Based on the luminance data, a luminance histogram is generated for all coordinates (all pixels of the plurality of image data). Then, the luminance value of the portion between the two peaks (valleys) appearing in the histogram is set as a threshold value, and the luminance of each coordinate is binarized depending on whether the luminance is larger than or smaller than the threshold value for each coordinate. This distinguishes whether the voxel of each coordinate is a spatial voxel or an object voxel. Such CT scanning can be performed using, for example, SMX-160CT-SV3 (trade name) manufactured by Shimadzu Corporation. The position of the partition wall 1 where CT scanning is performed is not particularly limited, but is preferably a central part in the extending direction of the cells 2 (the axial direction of the cell 2 described above) of the honeycomb structure 4.

This voxel data 60 is then used to model an inner structure of the partition wall 1 (e.g., the shape condition of the communication pore 31 in the partition wall 1) as shown in FIGS. 4 and 5. Then, the “Watershed algorithm”, an algorithm for separating contacting objects, is applied to the inner structure of the partition wall 1 modeled in this way, and first, the narrow part 35 where the diameter of the communication pore 31 is partially narrowed is specified. Further, for the specified narrow part 35, a virtual pore dividing surface 33 for virtually dividing the communication pore 31 into a virtual single pore 32 is obtained, and the area of the virtual pore dividing surface 33 is obtained. The equal area circle equivalent diameter of the virtual pore dividing surface 33 obtained in this manner is defined as a length corresponding to the width of the narrow part 35. That is, hereinafter, the “width of the narrow part 35” refers to the “equal area circle equivalent diameter of the virtual pore dividing surface 33 of the narrow part 35”.

Further, for each of the virtual single pores 32a, 32b, 32c, and 32d obtained by virtually dividing the communication pore 31 at the narrow part 35, the minimum widths X1, X2, X3, and X4 (μm) and the maximum widths Y1, Y2, Y3, and Y4 (μm) passing through the respective center of gravity O1 to O4 are obtained. The calculation of the minimum widths X1, X2, X3, and X4 (μm) and the maximum widths Y1, Y2, Y3, and Y4 (μm) is calculated in the program executing the Watershed algorithm described above.

Next, for each of the virtual single pores 32a, 32b, 32c, and 32d, the ratio of the minimum widths X1, X2, X3, and X4 (μm) to the maximum widths Y1, Y2, Y3, and Y4 (μm) is determined. For example, in FIG. 5, “X1/Y1” of the virtual single pore 32a, “X2/Y2” of the virtual single pore 32b, “X3/Y3” of the virtual single pore 32c, and “X4/Y4” of the virtual single pore 32d are calculated. Then, the values of “X/Y” of the virtual single pore 32 observed in the analysis area (480 μm×480 μm×300 μm) are individually obtained, and an average value of the obtained “X/Y” is calculated. The average value of “X/Y” is preferably a value obtained by determining values of “X/Y” of 2500 or more virtual single pores 32 by the analysis described so far and calculating the average of the values. That is, the sample size (in other words, the number of samples) for which the average value of “X/Y” is obtained is preferably 2500 or more. A sample size of 2500 or more to obtain the average value is a statistically significant number of samples.

Here, when the partition wall 1 of the honeycomb structure 4 is made of a porous body containing cordierite as a main component, the average value of the ratio (X/Y) of the minimum width X to the maximum width Y of the virtual single pore 32 is preferably 0.80 or more and 1.00 or less. With this configuration, the pore shape of the virtual single pore 32 becomes closer to the true sphere, and performance variations in pressure loss and filtration efficiency can be suppressed more effectively. The theoretical upper limit of the average value of X/Y is 1.00 when the minimum width X (μm) and the maximum width Y (μm) are the same value in all the virtual single pore 32, but the realistic preferable upper limit of the average value of X/Y can be 0.90. The average value of the ratio (X/Y) of the minimum width X to the maximum width Y of the virtual single pore 32 is further preferably 0.80 or more and 0.90 or less. On the other hand, when the partition wall 1 of the honeycomb structure 4 is made of a porous body containing silicon carbide as a main component, the average value of the ratio (X/Y) of the minimum width X to the maximum width Y of the virtual single pore 32 is preferably 0.58 or more and 1.00 or less.

It is preferable that a standard deviation of the ratio (X/Y) of the minimum width X to the maximum width Y of the virtual single pore 32 is 0.2 or less. The standard deviation of X/Y is preferably a value obtained by determining values of “X/Y” of 2500 or more virtual single pores 32 by the analysis described so far and calculating the average of the values. That is, the sample size (in other words, the number of samples) for which the average value of “X/Y” is obtained is preferably 2500 or more.

It is preferable that the average value of the equal area circle equivalent diameter of the virtual pore dividing surfaces 33 that virtually divide the communication pore 31 into virtual single pores 32a, 32b, 32c, and 32d at the narrow parts 35 is 8.8 to 30 μm. With this configuration, performance variations in pressure loss and filtration efficiency can be suppressed more effectively. In particular, when the partition wall 1 of the honeycomb structure 4 is made of a porous body containing silicon carbide as a main component, the average value of the equal area circle equivalent diameter of the virtual pore dividing surfaces 33 is preferably 9 to 30 μm.

A cell density of the honeycomb structure 4 is not particularly limited, but for example, the cell density of the honeycomb structure 4 is preferably 31 to 62 cells/cm², and more preferably 43 to 50 cells/cm². With this configuration, it is possible to effectively suppress an increase in pressure loss while maintaining the trapping performance of the honeycomb filter 100.

The shape of the cell 2 defined by the partition wall 1 is not particularly limited. For example, the shape of the cell 2 in the section that is orthogonal to the extending direction of the cells 2 may be polygonal, circular, elliptical or the like. Examples of the polygonal shape include a triangle, a quadrangle, a pentagon, a hexagon, and an octagon. The shape of the cell 2 is preferably triangular, quadrangular, pentagonal, hexagonal or octagonal. Further, regarding the shape of the cells 2, all the cells 2 may have the same shape or different shapes. For example, although not shown, quadrangular cells and octagonal cells may be combined. Further, regarding the size of the cells 2, all the cells 2 may have the same size or different sizes. For example, although not shown, some of the plurality of cells may be larger, and other cells may be smaller relatively. In the present invention, a cell means a space surrounded by a partition wall.

The shape of the honeycomb structure 4 is not particularly limited. Examples of the shape of the honeycomb structure 4 include a pillar shape in which the shapes of the inflow end face 11 and the outflow end face 12 are circular, elliptical, polygonal, or the like.

The size of the honeycomb structure 4, for example, the length from the inflow end face 11 to the outflow end face 12 and the size of the section orthogonal to the extending direction of the cells 2 of the honeycomb structure 4, are not particularly limited. Each size may be selected as appropriate such that optimum purification performance is obtained when the honeycomb filter 100 is used as a filter for purifying exhaust gas.

The material of the plugging portion 5 is not particularly limited. For example, the material may be the same as the material of the partition wall 1 described above, or may be a material different from the material of the partition wall 1.

In the honeycomb filter 100, the partition wall 1 defining the plurality of cells 2 is preferably loaded with a catalyst for purifying exhaust gas. Loading the partition wall 1 with a catalyst refers to coating the catalyst onto the surface of the partition wall 1 and the inner walls of the pores formed in the partition wall 1. With this configuration, it is possible to turn CO, NOx, HC, and the like in exhaust gas into harmless substances by catalytic reaction. In addition, the oxidation of PM of trapped soot or the like can be accelerated.

The catalyst loaded on the partition wall 1 is not particularly limited. For example, such catalysts may include a catalyst containing a platinum group element and containing an oxide of at least one element among aluminum, zirconium, and cerium.

### (2) Manufacturing Method of Honeycomb Filter

The manufacturing method of the honeycomb filter of the present invention is not particularly limited, and for example, when the partition wall of the honeycomb filter is made of a porous body containing cordierite as a main component, the following method can be cited. First, a plastic kneaded material for making a honeycomb structure is prepared. As a raw material powder for preparing the kneaded material, for example, kaolin, talc, alumina, aluminum hydroxide, silica, and the like are used, and the kneaded material can be prepared by making these raw material powders to have a chemical composition of 42 to 56% by mass of silica, 30 to 45% by mass of alumina, and 12 to 16% by mass of magnesia. For pore former, a mixture of a spherical pore former and a non-spherical pore former at a predetermined mixing ratio can be used. By using the spherical pore former having an average particle diameter of 10 to 25 μm, a kneaded material capable of preparing a porous body containing a large number of pore shapes close to true spheres of such a size can be obtained. The average particle diameter shall refer to the median diameter (D50) measured using a laser diffraction/scattering type particle size distribution measurement device.

Furthermore, as the spherical pore former used in the manufacturing method of the honeycomb filter of the present invention, starch-based (particularly wheat-derived) pore former is useful. Conventionally, the pore former used in the manufacture of ordinary honeycomb filters has difficulty in maintaining its spherical shape due to the swelling property during forming and when absorbing water. On the other hand, the starch-based pore former derived from wheat or the like can mitigate the effect. As the pore former used in the manufacturing method of the honeycomb filter of the present invention, for example, the average value of the ratio of the minimum minor diameter to the maximum major diameter (minimum minor diameter/maximum major diameter) is preferably 0.5 or more.

Next, the kneaded material thus obtained is subjected to extrusion to make a pillar-shaped honeycomb formed body having a partition wall defining a plurality of cells and a circumferential wall disposed so as to surround the partition wall. In the extrusion, a die in which a slit having an inverted shape of the honeycomb formed body to be formed is provided on the extruded surface of the kneaded material can be used as a die for extrusion.

The obtained honeycomb formed body is dried, for example, by microwave and hot air, and open end of the cell is plugged with a material similar to the material used for making the honeycomb formed body to form a plugging portion. After forming the plugging portion, the honeycomb formed body may be dried again.

Next, the honeycomb formed body on which the plugging portions have been formed was fired to manufacture a honeycomb filter. The firing temperature and the firing atmosphere differ according to the raw material, and those skilled in the art can select the firing temperature and the firing atmosphere that are the most suitable for the selected material.

In the above, the honeycomb filter made of cordierite has been described as an example, but the honeycomb filter in which the partition wall is made of a porous body containing silicon carbide as a main component can be manufactured by applying the same treatment to the kneaded material prepared by adding the same pore former, dispersing medium, and an organic binder to silicon carbide powder (silicon carbide).

### EXAMPLES

The following will describe in more detail the present invention by examples, but the present invention is not at all limited by the examples.

### Example 1

To 100 parts by mass of cordierite forming raw material, 2 parts by mass of pore former, 2 parts by mass of dispersing medium, and 7 parts by mass of an organic binder were added, respectively, and mixed and kneaded to prepare a kneaded material. As the cordierite forming raw material, alumina, aluminum hydroxide, kaolin, talc, and silica were used. As the dispersing medium, water was used. As the organic binder, methylcellulose was used. As the dispersing agent, dextrin was used. As the pore former, a mixture of the spherical pore former and the non-spherical pore former at a predetermined mixing ratio was used. In particular, as for the spherical pore former, the pore former having an average particle diameter of 15 μm and an average value of the ratio of the minimum minor diameter to the maximum major diameter of 0.5 or more was used. The average particle diameter is the median diameter (D50) measured using a laser diffraction/scattering type particle size distribution measurement device.

Next, the obtained kneaded material was molded using an extruder to make a honeycomb formed body. Next, the obtained honeycomb formed body was dried by high frequency dielectric heating, and then further dried using a hot air dryer. The shape of the cells in the honeycomb formed body was quadrangular.

Next, a plugging portion was formed on the dried honeycomb formed body. First, the inflow end face of the honeycomb formed body was masked. Next, the end portion provided with a mask (the end portion on the inflow end face side) was immersed in a plugging slurry, and the plugging slurry was filled into an open end of the unmasked cell (the outflow cell). In this way, a plugging portion was formed on the inflow end face side of the honeycomb formed body. Then, the plugging portion was also formed in the inflow cell in the same manner for the outflow end face of the dried honeycomb formed body.

Next, the honeycomb formed body on which the plugging portions have been formed was dried with a microwave dryer and completely dried in a hot air dryer, and then both end faces of the honeycomb formed body were cut and adjusted to a predetermined size. The dried honeycomb formed body was then degreased and calcined to manufacture a honeycomb filter of Example 1.

The honeycomb filter of Example 1 had an end face diameter of 118.4 mm and a length of 152.4 mm in the extending direction of the cells. In addition, the honeycomb filter had a thickness of the partition wall of 210.8 μm and a cell density of 47.3 cells/cm². The thickness of the partition wall and the cell density are shown in Table 1. In Example 1, 10 honeycomb filters of the same lot were made by the method described above. Hereinafter, as in Example 1 above, a plurality of (10 in Example 1) honeycomb filters made by the same method using the same raw material may be referred to as “the same lot product”.

For the honeycomb filter of Example 1, “Porosity (%)” and “Average Pore Diameter (μm)” of the partition wall were measured in the following manner. The results are shown in Table 1. In addition, the minimum width X (μm) and the maximum width Y (μm) of the virtual single pore obtained by virtually dividing the communication pore of the porous body constituting the partition wall at the narrow part were obtained by the methods described so far. Then, the ratio (X/Y) of the minimum width X (μm) to the maximum width Y (μm) of each virtual single pore was determined, and the average value thereof was calculated. The results are shown in the column of “Average value of X/Y” in Table 1. Further, the equal area circle equivalent diameter of the virtual pore dividing surface for virtually dividing the communication pore into virtual single pores was obtained by the method described above and the average value thereof was calculated. The results are shown in the column of “Average equal area circle equivalent diameter (μm) of Virtual pore dividing surface” in Table 1. The number of the virtual single pore used to calculate the respective average values described above was 2842. The number is shown in the column of “Number of Virtual single pore” in Table 1.

[Porosity (%) and Average Pore Diameter (μm)]

The porosity (%) and the average pore diameter (μm) of the partition wall were measured using Autopore 9500 (trade name) manufactured by Micromeritics. In these measurements, a part of partition wall was cut out from the honeycomb filter to obtain a test piece, and the measurement was performed using the obtained test piece. The test piece was a rectangular parallelepiped having a length, a width, and a height of approximately 10 mm, approximately 10 mm, and approximately 20 mm, respectively. The sampling location of the test piece was set in the vicinity of the center of the honeycomb structure in the axial direction.

TABLE 1

| | | Comparative | Example | Example | Example | Example | Example |
|---|---|---|---|---|---|---|---|
| | | Example 1 | 1 | 2 | 3 | 4 | 5 |
| Thickness of Partition wall (μm) | | 208.3 | 210.8 | 210.8 | 203.2 | 223.0 | 318.4 |
| Cell Density (cells/cm²) | | 46.7 | 47.3 | 46.8 | 48.8 | 50.8 | 48.2 |
| Porosity (%) | | 63.2 | 63.1 | 63.8 | 61.4 | 67.0 | 65.3 |
| Average Pore Diameter (μm) | | 15.6 | 18.7 | 15.6 | 33.7 | 23.5 | 12.4 |
| Average equal area circle equivalent diameter (μm) | | 10.0 | 16.4 | 10.4 | 15.1 | 26.1 | 10.9 |
| of Virtual pore dividing surface | | | | | | | |
| Average value of X/Y | | 0.50 | 0.58 | 0.57 | 0.59 | 0.56 | 0.60 |
| Standard deviation of X/Y | | 0.12 | 0.14 | 0.13 | 0.13 | 0.13 | 0.13 |
| Number of Virtual single pore (pores) | | 3430 | 2842 | 4017 | 3537 | 2896 | 6175 |
| Filtration | Average value of 10 of the same lot | 63.3 | 60.0 | 63.4 | 72.9 | 54.9 | 71.6 |
| efficiency | Maximum value | 66.5 | 62.1 | 65.7 | 75.4 | 56.9 | 74.1 |
| (%) | Minimum value | 60.7 | 57.8 | 61.2 | 76.5 | 52.8 | 69.2 |
| | Changing rate from Average value | 5.1% | 3.5% | 3.6% | 3.4% | 3.6% | 3.5% |
| | (Maximum value) | | | | | | |
| | Change rate from Average value | 4.1% | 3.7% | 3.5% | 3.3% | 3.8% | 3.4% |
| | (Minimum value) | | | | | | |
| | Maximum Changing rate (%) | 5.1% | 3.7% | 3.6% | 3.4% | 3.8% | 3.5% |
| Pressure | Average value of 10 of the same lot | 4.5 | 4.2 | 4.5 | 4.8 | 4.0 | 4.9 |
| loss | Maximum value | 4.7 | 4.2 | 4.6 | 4.9 | 4.1 | 4.9 |
| (kPa) | Minimum value | 4.3 | 4.1 | 4.4 | 4.7 | 3.9 | 4.8 |
| | Changing rate from Average value | 4.4% | 0.0% | 2.2% | 2.1% | 2.5% | 0.0% |
| | (Maximum value) | | | | | | |
| | Change rate from Average | 4.4% | 2.4% | 2.2% | 2.1% | 2.5% | 2.0% |
| | (Minimum value) | | | | | | |
| | Maximum Changing rate (%) | 4.4% | 2.4% | 2.2% | 2.1% | 2.5% | 2.0% |

| | | Example | Example | Example | Example | Example |
|---|---|---|---|---|---|---|
| | | 6 | 7 | 8 | 9 | 10 |
| Thickness of Partition wall (μm) | | 321.0 | 230.8 | 215.9 | 259.1 | 259.6 |
| Cell Density (cells/cm²) | | 47.9 | 47.9 | 46.3 | 43.6 | 32.1 |
| Porosity (%) | | 66.4 | 05.6 | 63.5 | 53.9 | 50.4 |
| Average Pore Diameter (μm) | | 14.8 | 16.1 | 14.0 | 8.6 | 9.7 |
| Average equal area circle equivalent diameter (μm) | | 19.3 | 18.6 | 15.0 | 8.8 | 9.9 |
| of Virtual pore dividing surface | | | | | | |
| Average value of X/Y | | 0.58 | 0.58 | 0.85 | 0.35 | 0.54 |
| Standard deviation of X/Y | | 0.12 | 0.12 | 0.13 | 0.13 | 0.13 |
| Number of Virtual single pore (pores) | | 4271 | 3461 | 3530 | 9108 | 7352 |
| Filtration | Average value of 10 of the same lot | 75.0 | 73.2 | 71.0 | 0.9 | 0.9 |
| efficiency | Maximum value | 77.6 | 75.7 | 71.9 | 0.9 | 0.9 |
| (%) | Minimum value | 72.3 | 70.6 | 70.1 | 9.9 | 0.9 |
| | Changing rate from Average value | 3.5% | 3.4% | 1.3% | 0.3% | 1.2% |
| | (Maximum value) | | | | | |
| | Change rate from Average value | 3.6% | 3.6% | 1.3% | 0.8% | 1.1% |
| | (Minimum value) | | | | | |
| | Maximum Changing rate (%) | 3.6% | 3.6% | 1.3% | 0.8% | 1.29% |
| Pressure | Average value of 10 of the same lot | 5.0 | 4.3 | 4.6 | 1.6 | 0.9 |
| loss | Maximum value | 5.1 | 4.4 | 4.7 | 1.6 | 0.9 |
| (kPa) | Minimum value | 4.9 | 4.2 | 4.6 | 1.6 | 0.9 |
| | Changing rate from Average value | 2.0% | 2.3% | 2.2% | 0.6% | 0.4% |
| | (Maximum value) | | | | | |
| | Change rate from Average value | 2.0% | 2.3% | 0.0% | 1.9% | 0.4% |
| | (Minimum value) | | | | | |
| | Maximum Changing rate (%) | 2.0% | 2.3% | 2.2% | 1.5% | 0.4% |

On the honeycomb filter of Example 1, the filtration efficiency and the pressure loss were evaluated according to the method described below. Table 1 shows the result.

### [Filtration Efficiency]

The honeycomb filter was mounted at the underfloor position of a vehicle with a displacement of 1500 cc, and a bench test in the running mode RTS95 cycle was performed, during which exhaust gas containing PM was passed through the honeycomb filter. At this time, the filtration efficiency (%) of the honeycomb filter was determined by measuring the number of PM in exhaust gas prior to flowing into the honeycomb filter and the number of PM in exhaust gas flowing out of the honeycomb filter. The filtration efficiency (%) was measured for 10 honeycomb filters of the same lot, and the average value of the filtration efficiency (%) and the maximum value and the minimum value of the filtration efficiency (%) of 10 honeycomb filters of the same lot were determined. Among 10 honeycomb filters of the same lot, the changing rate from the average value was determined for the honeycomb filters showing the maximum value and the minimum value of the filtration efficiency (%). The changing rate (%) from the average value is a value obtained by calculating a difference between the maximum value or the minimum value and the average value, dividing the obtained difference by the average value, and multiplying the result by 100. Then, the maximum value and the minimum value of the filtration efficiency (%) were compared in terms of the magnitude of “the changing rate (%) from the average value”, and the one showing the larger value of the changing rate (%) (hereinafter also referred to as the “maximum changing rate”) was used to evaluate the filtration efficiency. In the evaluation of the filtration efficiency, a maximum changing rate in filtration efficiency (%) of less than 5.0% was considered as passing, and a maximum changing rate in filtration efficiency (%) greater than 5.0% was considered as failing.

### [Pressure Loss]

A gas at 25° C. was flowed in at a flow rate of 10 m³/minute using a large wind tunnel tester to measure the pressure on the inflow end face side and the outflow end face side of the honeycomb filter. Then, the pressure loss (kPa) of the honeycomb filters was determined by calculating the pressure difference between the inflow end face side and the outflow end face side. The pressure loss (kPa) was measured on 10 honeycomb filters of the same lot, and the average value of the pressure loss (kPa) and the maximum value and the minimum value of the pressure loss (kPa) of 10 honeycomb filters of the same lot were determined. Among the 10 honeycomb filters of the same lot, the changing rate (%) from the average value was determined for the honeycomb filters showing the maximum and value and the minimum value of the pressure loss (kPa). The changing rate (%) from the average value is a value obtained by calculating a difference between the maximum value or the minimum value and the average value, dividing the obtained difference by the average value, and multiplying the result by 100. Then, the maximum value and the minimum value of the pressure loss (kPa) were compared in terms of the magnitude of “the changing rate (%) from the average value”, and the one showing the larger value of the changing rate (%) (hereinafter also referred to as the “maximum changing rate”) was used to evaluate the pressure loss. In the evaluation of the pressure loss, a maximum changing rate in pressure loss (kPa) of less than 4.0% was considered as passing, and a maximum changing rate in pressure loss (kPa) greater than 4.0% was considered as failing.

### Examples 2 to 10

In Examples 2 to 10, the configuration of the honeycomb structure was changed as shown in Table 1. In Examples 2 to 10, the mixing ratio of the spherical pore former and the non-spherical pore former was adjusted, and the honeycomb structure was prepared so as to have a configuration of Examples 2 to 10 as shown in Table 1. In Examples 2 to 8, the diameters of the end face and the lengths in the extending direction of the cells are almost the same as those in Example 1, and Examples 1 and 2 to 8 are gasoline particulate filters (GPF). On the other hand, Example 9 and Example 10 are diesel particulate filters (DPF) that differ in size from Example 1. Specifically, in Example 9, the diameter of the end face is 266.7 mm, and the length in the extending direction of the cells is 127 mm, while in Example 10, the diameter of the end face is 304.8 mm, and the length in the extending direction of the cells is 203.2 mm.

### (Comparative Example 1)

In Comparative Example 1, the configuration of the honeycomb structure was changed as shown in Table 1. In Comparative Example 1, the honeycomb structure was prepared using crushed pore former, kaolin, alumina, and aluminum hydroxide. In Comparative Example 1, the diameter of the end face and the length in the extending direction of the cells are almost the same as those in Example 1.

The honeycomb filters of Examples 2 to 8 and Comparative Example 1 were also evaluated for filtration efficiency and pressure loss in the same manner as in Example 1. Table 1 shows the result. In Examples 9 and 10, the measurement conditions were changed because the sizes of the honeycomb filters were larger than those of Examples 1 to 8 and Comparative Example 1. Specifically, for the measurement of filtration efficiency, the bench test was changed to perform with a displacement of 6700 cc and in the running mode WHTC cycling. For the measurement of pressure loss, the flow rate of the gas was changed to 20 m³/minute. The other measurement conditions are the same, and the evaluation method is the same. The results of Examples 9 and 10 are also shown in Table 1.

### (Results)

The honeycomb filters of Examples 1 to 10 met the evaluation criteria for both filtration efficiency and pressure loss and were evaluated as passed. That is, the honeycomb filters of Examples 1 to 10 had less performance variations in pressure loss and filtration efficiency for 10 honeycomb filters of the same lot product. On the other hand, the honeycomb filter of Comparative Example 1 had large performance variations in pressure loss and filtration efficiency for 10 honeycomb filters of the same lot product. Among Examples 1 to 10, Example 8 in which an average value of the ratio (X/Y) was 0.80 or more, and Examples 9 and 10 in which an average pore diameter of the partition wall was 10um or less, had a maximum changing width of the filtration efficiency of 1.3% or less, and had less performance variations as compared with Examples 1 to 7, which did not satisfy any of these requirements.

### Example 11

To 100 parts by mass of ceramics raw material having a mass ratio of silicon carbide powder (silicon carbide) to metal Si powder of 80:20, 15 parts by mass of pore former, 0.1 parts by mass of dispersing medium, and 7 parts by mass of an organic binder were added, respectively, and mixed and kneaded to prepare a kneaded material. As the dispersing medium, water was used. As the organic binder, methylcellulose was used. As the dispersing agent, dextrin was used. As the pore former, a mixture of pore former of the spherical pore former and the non-spherical pore former at a predetermined mixing ratio was used. In particular, as the spherical pore former, the one having an average particle diameter of 30 μm and an average value of the ratio of the minimum minor diameter to the maximum minor diameter of 0.5 or more was used. The average particle diameter is the median diameter (D50) measured using a laser diffraction/scattering type particle size distribution measurement device.

Next, the obtained kneaded material was molded using an extruder to make a honeycomb formed body. Next, the obtained honeycomb formed body was dried by high frequency dielectric heating, and then further dried using a hot air dryer. The shape of the cells in the honeycomb formed body was quadrangular.

Next, a plugging portion was formed on the dried honeycomb formed body. First, the inflow end face of the honeycomb formed body was masked. Next, the end portion provided with a mask (the end portion on the inflow end face side) was immersed in a plugging slurry, and the plugging slurry was filled into an open end of the unmasked cell (the outflow cell). In this way, a plugging portion was formed on the inflow end face side of the honeycomb formed body. Then, the plugging portion was also formed in the inflow cell in the same manner for the outflow end face of the dried honeycomb formed body.

Next, the honeycomb formed body on which the plugging portions have been formed was dried with a microwave dryer and completely dried in a hot air dryer, and then both end faces of the honeycomb formed body were cut and adjusted to a predetermined size. The dried honeycomb formed body was then degreased and calcined to manufacture a honeycomb filter of Example 11.

The honeycomb filter of Example 11 had an end face diameter of 143.8 mm and a length of 177.8 mm in the extending direction of the cells. In addition, the honeycomb filter had a thickness of the partition wall of 235.5 μm and a cell density of 45.0 cells/cm². The thickness of the partition wall and the cell density are shown in Table 2. In Example 11, 10 honeycomb filters of the same lot were made in the same manner as in Example 1.

For the honeycomb filter of Example 11, the porosity (%) and the average pore diameter (μm) of the partition wall, the average value of the ratio (X/Y), and the average value of the equal area circle equivalent diameter of the virtual pore dividing surface were obtained in the same manner as in Example 1. Table 2 shows each value. Here, the number of the virtual single pore was 3448, which is also shown in Table 2.

TABLE 2

| | | Comparative | Example | Example | Example | Example | Example | Example |
|---|---|---|---|---|---|---|---|---|
| | | Example 2 | 11 | 12 | 13 | 14 | 15 | 16 |
| Thickness of Partition wall (μm) | | 250.1 | 235.5 | 257.6 | 301.0 | 249.1 | 253.8 | 255.5 |
| Cell Density (cells/cm²) | | 45.4 | 45 | 46 | 44.1 | 46.1 | 45.8 | 46.3 |
| Porosity (%) | | 41.1 | 45 | 36.5 | 63.2 | 47.9 | 40.3 | 41.6 |
| Average Pore Diameter (μm) | | 10.5 | 11.2 | 10.9 | 20.1 | 12.8 | 10.7 | 9.3 |
| Average equal area circle equivalent diameter (μm) | | 10 | 14.3 | 13.4 | 16.1 | 15.3 | 12.2 | 9.5 |
| of Virtual pore dividing surface | | | | | | | | |
| Average value of X/Y | | 0.50 | 0.51 | 0.57 | 0.60 | 0.58 | 0.59 | 0.61 |
| Standard deviation of X/Y | | 0.13 | 0.15 | 0.14 | 0.14 | 0.13 | 0.12 | 0.14 |
| Number of Virtual single pore (pores) | | 3012 | 3448 | 5841 | 3510 | 3321 | 3480 | 3620 |
| Filtration | Average value of 10 of the same lot | 93.0 | 92.0 | 92.4 | 79.1 | 89.8 | 92.7 | 94.6 |
| efficiency | Maximum value | 97.4 | 95.9 | 95.8 | 81.7 | 92.8 | 95.8 | 97.5 |
| (%) | Minimum value | 88.3 | 87.7 | 89.1 | 76.6 | 86.7 | 89.5 | 91.8 |
| | Changing rate from Average value | 4.7% | 4.2% | 3.7% | 3.3% | 3.3% | 3.3% | 3.1% |
| | (Maximum value) | | | | | | | |
| | Change rate from Average value | 5.1% | 4.7% | 3.6% | 3.2% | 3.5% | 3.5% | 3.0% |
| | (Minimum value) | | | | | | | |
| | Maximum Changing rate (%) | 5.1% | 4.5% | 4.2% | 3.3% | 3.1% | 3.5% | 3.1% |
| Pressure | Average value of 10 of the same lot | 4.4 | 5.1 | 4.6 | 5.1 | 4.2 | 4.4 | 4.5 |
| loss | Maximum value | 4.6 | 5.2 | 4.7 | 5.2 | 4.3 | 4.4 | 4.6 |
| (kPa) | Minimum value | 4.2 | 4.9 | 4.5 | 5.0 | 4.1 | 4.3 | 4.5 |
| | Changing rate from Average value | 4.5% | 2.0% | 2.2% | 2.0% | 2.4% | 0.0% | 2.2% |
| | (Maximum value) | | | | | | | |
| | Change rate from Average value | 4.5% | 3.9% | 2.2% | 2.0% | 2.4% | 2.3% | 0.0% |
| | (Minimum value) | | | | | | | |
| | Maximum Changing rate (%) | 4.5% | 3.9% | 2.2% | 2.0% | 2.4% | 2.3% | 2.2% |

On the honeycomb filter of Example 11, the filtration efficiency and the pressure loss were evaluated according to the method described below. Table 2 shows the result.

### [Filtration Efficiency]

The honeycomb filter was mounted at the underfloor position of a vehicle with a diesel engine with a displacement of 3500 cc, and a bench test in the running mode WLTC cycle was performed, during which exhaust gas containing PM was passed through the honeycomb filter. At this time, the filtration efficiency (%) of 10 honeycomb filters of the same lot product was determined by measuring the number of PM in exhaust gas prior to flowing into the honeycomb filter and the number of PM in exhaust gas flowing out of the honeycomb filter. Then, the maximum changing rate of the filtration efficiency (%) was determined in the same manner as in Example 1, and a maximum changing rate of less than 5.0% was considered as passing, and a maximum changing rate greater than 5.0% was considered as failing.

### [Pressure Loss]

A gas at 25° C. was flowed in at a flow rate of 10 m³/minute using a large wind tunnel tester to measure the pressure on the inflow end face side and the outflow end face side of the honeycomb filter. Then, the pressure loss (kPa) of 10 honeycomb filters of the same lot product was determined by calculating the pressure difference between the inflow end face side and the outflow end face side. Then, the maximum changing rate in pressure loss (kPa) was determined in the same manner as in Example 1, and a maximum changing rate of less than 4.0% was considered as passing, and a maximum changing rate greater than 4.0% was considered as failing.

### Examples 12 to 16

In Examples 12 to 16, the configuration of the honeycomb structure was changed as shown in Table 2. In Examples 12 to 16, the mixing ratio of the spherical pore former and the non-spherical pore former was adjusted, and the honeycomb structure was prepared so as to have a configuration of Examples 12 to 16 as shown in Table 2. Here, Example 11 and Examples 12 to 16 described above are diesel particulate filters (DPF).

### (Comparative Example 2)

In Comparative Example 2, the configuration of the honeycomb structure was changed from Example 11 as shown in Table 2. In Comparative Example 2, a crushed pore former was used to prepare the honeycomb structure.

The honeycomb filters of Examples 12 to 16 and Comparative Example 2 were also evaluated for filtration efficiency and pressure loss in the same manner as in Example 11. Table 2 shows the result.

### (Results)

The honeycomb filters of Examples 11 to 16 met the evaluation criteria for both filtration efficiency and pressure loss and were evaluated as passed. That is, the honeycomb filters of Examples 11 to 16 had less performance variations in pressure loss and filtration efficiency for 10 honeycomb filters of the same lot product. On the other hand, the honeycomb filter of Comparative Example 2 had large performance variations in pressure loss and filtration efficiency for 10 honeycomb filters of the same lot product. Among Examples 11 to 16, Examples 13 to 16 in which an average value of the ratio (X/Y) was 0.58 or more had a maximum changing width of the filtration efficiency of 3.3% or less and had less performance variations in filtration efficiency as compared with Examples 11 and 12, which did not satisfy this requirement.

### INDUSTRIAL APPLICABILITY

The honeycomb filter of the present invention can be used as a filter for trapping particulate matter in exhaust gas.

### DESCRIPTION OF REFERENCE NUMERALS

1: partition wall, 2: cell, 2a: inflow cell: 2b: outflow cell, 3: circumferential wall, 4: honeycomb structure, 5: plugging portion, 11: inflow end face, 12: outflow end face, 31: communication pore, 32, 32a, 32b, 32c, and 32d: virtual single pore, 33: virtual pore dividing surface, 35: narrow part, 60: voxel data, 100: honeycomb filter, O1, O2, O3, and O4: center of gravity, X, X1, X2, X3, and X4: minimum width, Y, Y1, Y2, Y3, and Y4: maximum width.

1. A honeycomb filter comprising: a pillar-shaped honeycomb structure having a porous partition wall disposed so as to surround a plurality of cells which serve as fluid through channels extending from an inflow end face to an outflow end face; and
a plugging portion provided at either an end on the inflow end face side or an end on the outflow end face side of the cell; wherein
a thickness of the partition wall is 152 to 305 μm,
a porosity of the partition wall is 35% or more and 70% or less,
an average pore diameter of the partition wall is 7 μm or more and 24 μm or less,
a porous body constituting the partition wall has a communication pore which opens to the surface of the partition wall and communicates with a pore inside the partition wall, and the communication pore has a narrow part in which a diameter of the communication pore is partially narrowed in the partition wall, and
in a virtual single pore obtained by virtually dividing the communication pore at the narrow part, when a minimum width passing through the center of gravity of each of the virtual single pore is defined as X (μm) and a maximum width passing through the center of gravity of each of the virtual single pore is defined as Y (μm), an average value of a ratio (X/Y) of the minimum width X to the maximum width Y of the virtual single pore is 0.51 or more and 1.00 or less.

2. The honeycomb filter according to claim 1, wherein a standard deviation of the ratio (X/Y) of the minimum width X to the maximum width Y of the virtual single pore is 0.2 or less.

3. The honeycomb filter according to claim 1, wherein an average value of an equal area circle equivalent diameter of virtual pore dividing surfaces that virtually divide the communication pore into the virtual single pores at the narrow part is 8.8 to 30 μm.

4. The honeycomb filter according to claim 1, wherein a porosity of the partition wall is 45% or more, and
the partition wall is made of a porous body containing cordierite as a main component.

5. The honeycomb filter according to claim 4, wherein an average value of the ratio (X/Y) of the minimum width X to the maximum width Y of the virtual single pore is 0.80 or more and 1.00 or less.

6. The honeycomb filter according to claim 4, wherein an average pore diameter of the partition wall is 10 μm or less.

7. The honeycomb filter according to claim 1, wherein the partition wall is made of a porous body containing silicon carbide as a main component.

8. The honeycomb filter according to claim 7, wherein an average value of the ratio (X/Y) of the minimum width X to the maximum width Y of the virtual single pore is 0.58 or more and 1.00 or less.

9. The honeycomb filter according to claim 7, wherein an average value of the equal area circle equivalent diameter of the virtual pore dividing surfaces that virtually divide the communication pore into the virtual single pores at the narrow part is 9 to 30 μm.
